(19) United States
(12) Patent Application Publication
(10) Pub. No.: US 2014/0210355 A1
(43) Pub. Date: Jul. 31, 2014

(54) METHODS, CIRCUITS AND SYSTEMS FOR ADJUSTING CHROMATICITY OF SOLID STATE LIGHTING

(71) Applicant: Cree, Inc., Durham, NC (US)

(72) Inventors: Mark Cash, Raleigh, NC (US); Shawn Hill, Raleigh, NC (US)

(73) Assignee: Cree, Inc., Durham, NC (US)

(21) Appl. No.: 14/227,626

(22) Filed: Mar. 27, 2014

Related U.S. Application Data
(63) Continuation-in-part of application No. 13/742,008, filed on Jan. 15, 2013.
(60) Provisional application No. 61/808,553, filed on Apr. 4, 2013.
(60) Provisional application No. 61/808,519, filed on Apr. 4, 2013.

(51) Int. Cl. H05B 33/08

(52) U.S. Cl. CPC H05B 33/0869
USPC 315/151

(57) ABSTRACT

A plurality of light-emitting devices (LEDs), included in at least a string, can include at least one first LED configured to emit first chromaticity light, at least one second LED configured to emit second chromaticity light, and at least one additional LED configured to emit additional chromaticity light, wherein the at least one string can be operated by modulating the first modulated LED segment and/or the at least one additional modulated LED segment based on respective specified chromaticity values of the plurality of LEDs to provide the light substantially in conformance with a Planckian locus. The chromaticity of the light emitted by the at least one string can b e measured to provide a measured chromaticity value and the modulation of the first modulated LED segment or the at least one additional modulated LED segment can be adjusted by a shift value based on a difference between the measured chromaticity value and a specified chromaticity value to provide an additional v′ shift in light toward the Planckian locus.

### CROSS-REFERENCE TO RELATED APPLICATION

The present application claims the priority of U.S. Provisional Application Ser. No. 61/808,553, filed on Apr. 4, 2013 (Attorney Docket No. 5308-2013PR), and of U.S. Provisional Application Ser. No. 61/808,519, filed on Apr. 4, 2013 (Attorney Docket No. 5308-2065PR), and of U.S. Non-Provisional Application Ser. No. ______ filed on ______, 2014 (Attorney Docket No. 5308-2065) entitled CIRCUITS AND METHODS FOR CONTROLLING SOLID STATE LIGHTING, and is a Continuation-in-part of U.S. Non-provisional application Ser. No. 13/742,008, filed on Jan. 15, 2013 (Attorney Docket No. 5308-1955), the entire disclosures of which are incorporated herein by reference.

### FIELD OF THE INVENTION

The present invention relates to lighting apparatuses and methods and, more particularly, to solid state lighting apparatuses and methods.

### BACKGROUND

Solid state lighting arrays are used for a number of lighting applications. For example, solid state lighting panels including arrays of solid state light emitting devices have been used as direct illumination sources, for example, in architectural and/or accent lighting. A solid state light emitting device may include, for example, a packaged light emitting device including one or more light emitting diodes (LEDs), which may include inorganic LEDs, which may include semiconductor layers forming p-n junctions, and/or organic LEDs (OLEDs), which may include organic light emission layers.

Visible light may include light having many different wavelengths. The apparent color of visible light can be illustrated with reference to a two dimensional chromaticity diagram, such as the 1931 International Conference on Illumination (CIE) Chromaticity Diagram illustrated in FIG. 1A, and the 1976 CIE u′v′ Chromaticity Diagram shown in FIG. 1B, which is similar to the 1931 Diagram but is modified such that similar distances on the 1976 u′v′ CIE Chromaticity Diagram represent similar perceived differences in color. These diagrams provide useful reference for defining colors as weighted sums of colors.

In the 1976 CIE Chromaticity Diagram, chromaticity values are plotted using scaled u- and v-parameters which take into account differences in human visual perception. That is, the human visual system is more responsive to certain wavelengths than others. For example, the human visual system is more responsive to green light than red/orange light. The 1976 CIE-u′v′ Chromaticity Diagram is scaled such that the mathematical distance from one chromaticity point to another chromaticity point on the diagram is proportional to the difference in color perceived by a human observer between the two chromaticity points. A chromaticity diagram in which the mathematical distance from one chromaticity point to another chromaticity point on the diagram is proportional to the difference in color perceived by a human observer between the two chromaticity points may be referred to as a perceptual chromaticity space. In contrast, in a non-perceptual chromaticity diagram, such as the 1931 CIE Chromaticity Diagram, two colors that are not distinguishably different may be located farther apart on the graph than two colors that are distinguishably different.

As shown in FIG. 1A, colors on a 1931 CIE Chromaticity Diagram are defined by x and y coordinates (i.e., chromaticity coordinates, or color points) that fall within a generally U-shaped area. Colors on or near the outside of the area are saturated colors composed of light having a single wavelength, or a very small wavelength distribution. Colors on the interior of the area are unsaturated colors that are composed of a mixture of different wavelengths. White light, which can be a mixture of many different wavelengths, is generally found near the middle of the diagram, in the region labeled 100 in FIG. 1A. There are many different hues of light that may be considered “white,” as evidenced by the size of the region 100. For example, some “white” light, such as light generated by sodium vapor lighting devices, may appear yellowish in color, while other “white” light, such as light generated by some fluorescent lighting devices, may appear more bluish in color.

Light that generally appears green is plotted in the regions 101, 102 and 103 that are above the white region 100, while light below the white region 100 generally appears pink, purple or magenta. For example, light plotted in regions 104 and 105 of FIG. 1A generally appears magenta (i.e., red-purple or purplish red).

It is further known that a binary combination of light from two different light sources may appear to have a different color than either of the two constituent colors. The color of the combined light may depend on the relative intensities of the two light sources. For example, light emitted by a combination of a blue source and a red/orange source may appear purple or magenta to an observer. Similarly, light emitted by a combination of a blue source and a yellow source may appear white to an observer.

Also illustrated in FIG. 1A is the Planckian locus 106, which corresponds to the location of color points of light emitted by a black-body radiator that is heated to various temperatures. In particular, FIG. 1A includes temperature listings along the Planckian locus. These temperature listings show the color path of light emitted by a black-body radiator that is heated to such temperatures. As a heated object becomes incandescent, it first glows reddish, then yellowish, then white, and finally bluish, as the wavelength associated with the peak radiation of the black-body radiator becomes progressively shorter with increased temperature. Illuminants which produce light which is on or near the Planckian locus can thus be described in terms of their correlated color temperature (CCT).

The chromaticity of a particular light source may be referred to as the “color point” of the source. For a white light source, the chromaticity may be referred to as the “white point” of the source. As noted above, the white point of a white light source may fall along the Planckian locus. Accordingly, a white point may be identified by a correlated color temperature (CCT) of the light source. White light typically has a CCT of between about 2000 K and 10000 K. White light with a CCT of 3000, may appear yellowish in color, while light with a CCT of 8000 K may appear more bluish in color. Color coordinates that lie on or near the Planckian locus at a color temperature between about 2500 K and 8000 K may yield pleasing white light to a human observer.

“White” light also includes light that is near, but not directly on the Planckian locus. A Macadam ellipse can be used on a 1931 CIE Chromaticity Diagram to identify color points that are so closely related that they appear the same, or substantially similar, to a human observer. A Macadam ellipse is a closed region around a center point in a two-dimensional chromaticity space, such as the 1931 CIE Chromaticity Diagram, that encompasses all points that are visually indistinguishable from the center point. A seven-step Macadam ellipse captures points that are indistinguishable to an ordinary observer within seven standard deviations, a ten step Macadam ellipse captures points that are indistinguishable to an ordinary observer within ten standard deviations, and so on. Accordingly, light having a color point that is within about a ten step Macadam ellipse of a point on the Planckian locus may be considered to have a substantially similar color as the point on the Planckian locus.

The ability of a light source to accurately reproduce color in illuminated objects is typically characterized using the color rendering index (CRI). In particular, CRI is a relative measurement of how the color rendering properties of an illumination system compare to those of a reference illuminator, with a reference illuminator for a CCT of less than 5000K being a black-body radiator. For CCT of 5000K and above, the reference illuminator is a spectrum defined by the CIE which is similar to the spectrum of sunlight at the earth's surface. The CRI equals 100 if the color coordinates of a set of test colors being illuminated by the illumination system are the same as the coordinates of the same test colors being irradiated by the reference illuminator. Daylight has the highest CRI (of 100), with incandescent bulbs being relatively close (about 95), and fluorescent lighting being less accurate (70-85).

Generally speaking, incandescent bulbs tend to produce more natural-appearing illumination than other types of conventional lighting devices. In particular, incandescent bulbs typically go from a color temperature of about 2700K at full brightness to a color temperature of about 2000k at 5% brightness and to a color temperature of about 1800K at about 1% brightness. This compares favorably with daylight, which varies from about 6500K at midday to about 2500k at sunrise and sunset. Research indicates that people tend to prefer warmer color temperatures at low brightness levels and in intimate settings.

In illumination applications, it is often desirable to provide a lighting source that generates a light with a color behavior that approximates the behavior of incandescent lighting. LED-lighting units have been proposed that may be coupled to an AC dimmer circuit and approximate the lighting variation of a conventional incandescent light as the dimmer circuit increases or decreases the brightness of the generated light, as described in U.S. Pat. No. 7,038,399 to Lys et al.

One difficulty with solid state lighting systems including multiple solid state devices is that the manufacturing process for LEDs typically results in variations between individual LEDs. This variation is typically accounted for by binning, or grouping, the LEDs based on brightness, and/or color point, and selecting only LEDs having predetermined characteristics for inclusion in a solid state lighting system. LED lighting devices may utilize one bin of LEDs, or combine matched sets of LEDs from different bins, to achieve repeatable color points for the combined output of the LEDs.

One technique to tune the color point of a lighting fixture is described in commonly assigned United States Patent Publication No. 2009/0160363, the disclosure of which is incorporated herein by reference. The '363 application describes a system in which phosphor converted LEDs and red/orange LEDs are combined to provide white light. The ratio of the various mixed colors of the LEDs is set at the time of manufacture by measuring the output of the light and then adjusting string currents to reach a desired color point. The current levels that achieve the desired color point are then fixed for the particular lighting device. LED lighting systems employing feedback to obtain a desired color point are described in U.S. Publication Nos. 2007/0115662 and 2007/0115228, the disclosures of which are incorporated herein by reference.

It is known to adjust the correlated color temperature (CCT) of light generated by a solid state lighting apparatus during manufacturing. If the generated light does not meet a specified CCT value for the module, some of the LEDs on the module may be replaced in an attempt to bring the module into compliance with the specified CCT target. For example, interpreted using the CIE chromaticity diagrams in FIGS. 1A and 1B, the color of the light generated by binned LEDs used to manufacture the module, such as Blue-Shifted-Yellow (BSY) LED, may be distributed over 5 MacAdam ellipses. The specified CCT target may, however, only allow for a variation of 2 MacAdam ellipses. Accordingly, the distribution in CCT for the LEDs used for the module may combine to generate light having a CCT that varies more than that allowed.

### SUMMARY

Embodiments according to the invention can provide methods, circuits and systems for adjusting chromaticity of solid-state lighting. Pursuant to these embodiments, a plurality of light-emitting devices (LEDs), included in at least a string, can include at least one first LED configured to emit first chromaticity light, at least one second LED configured to emit second chromaticity light, and at least one additional LED configured to emit additional chromaticity light, wherein the at least one string can be operated by modulating the first modulated LED segment and/or the at least one additional modulated LED segment based on respective specified chromaticity values of the plurality of LEDs to provide the light substantially in conformance with a Planckian locus. The chromaticity of the light emitted by the at least one string can b e measured to provide a measured chromaticity value and the modulation of the first modulated LED segment or the at least one additional modulated LED segment can be adjusted by a shift value based on a difference between the measured chromaticity value and a specified chromaticity value to provide an additional v′ shift in light toward the Planckian locus.

In some embodiments according to the invention, the modulating can be provided by applying respective pulse width modulation signals to respective bypass circuits to conduct respective currents around the first modulated LED segment and/or the at least one additional modulated LED segment to emit a first chromaticity light and an additional chromaticity light, respectively. In some embodiments according to the invention, adjusting the modulation can be provided by changing at least one of the respective pulse width modulation signals to the respective bypass circuits by the shift value to shift the light in a v′ direction toward the specified chromaticity value.

In some embodiments according to the invention, the method can further include storing the shift value for use during operation of the lighting apparatus after installation. In some embodiments according to the invention, the shift value increases an on time of the respective pulse width modulation signal if a specified chromaticity value of the light emitted by the apparatus is less than the measured chromaticity of the light. In some embodiments according to the invention, the specified chromaticity value of the light emitted by the apparatus is less than the measured chromaticity value in the v′ direction of a u′-v′ chromaticity coordinate space.

In some embodiments according to the invention, the shift value decreases an on time of the respective pulse width modulation signal if the specified chromaticity value of the light emitted by the apparatus is greater than the measured chromaticity value in the v′ direction of a u′-v′ chromaticity coordinate space.

In some embodiments according to the invention, a system to adjust a chromaticity of light emitted by a solid state lighting apparatus can including plurality of light-emitting devices (LEDs) coupled together in a at least one string including a first modulated LED segment, a second modulated LED segment, and at least one additional modulated LED segment. The system can include a colorimeter configured to measure the chromaticity of the light emitted by the apparatus to provide a measured chromaticity value. A control circuit can be coupled to the colorimeter to receive the measured chromaticity value and configured to couple to the solid state lighting apparatus, wherein the control circuit is configured to modulate the first modulated LED segment and/or the at least one additional modulated LED segment based on respective specified chromaticity values of the plurality of LEDs to provide the light substantially in conformance with a Planckian locus, wherein the control circuit can be configured to adjust modulation of the first modulated LED segment or the at least one additional modulated LED segment by a shift value based on a difference between the measured chromaticity value and a specified chromaticity value to provide an additional v′ shift in light toward the Planckian locus.

In some embodiments according to the invention, a method of operating a lighting apparatus can be provided where the apparatus can include a single string of a plurality of light-emitting devices (LEDs) including at least one first LED configured to emit first chromaticity light, at least one second LED configured to emit second chromaticity light, and at least one additional LED configured to emit additional chromaticity light. The method can include measuring a CCT value for light emitted by the single string and adjusting current through the at least one additional LED using pulse width modulation responsive to determining that the CCT value for the light emitted by the single string is outside a predetermined specified CCT value in a v′ direction of a chromaticity coordinate space.

In some embodiments according to the invention, a method of adjusting a chromaticity of light emitted by a solid state lighting apparatus can be provided where the apparatus can include a plurality of light-emitting devices (LEDs) including a first modulated LED segment in a string, a second modulated LED segment in the string, and at least one additional modulated LED segment. The method can include modulating the first modulated LED segment and/or the at least one additional modulated LED segment based on respective specified chromaticity values of the plurality of LEDs to provide the light substantially in conformance with a Planckian locus. The chromaticity of the light emitted by the apparatus can be measured to provide a measured chromaticity value and the modulation of the first modulated LED segment or the at least one additional modulated LED segment can be adjusted by a shift value based on a difference between the measured chromaticity value and a specified chromaticity value to provide an additional v′ shift in light toward the Planckian locus.

### BRIEF DESCRIPTION OF THE DRAWINGS

FIG. 1A is a chromaticity diagram illustrating a Planckian locus using x and y chromaticity coordinates.

FIG. 1B is a chromaticity diagram using u′ and v′ chromaticity coordinates.

FIG. 2 is an x-y chromaticity diagram (annotated with an offset u′ and v′ coordinate system) illustrating the Planckian locus in some embodiments according to the invention.

FIG. 3 is single string LED lighting apparatus including bypass circuits coupled across respective LEDs in some embodiments according to the invention.

FIG. 4 is a block diagram illustrating a manufacturing system used to monitor and adjust the bypass circuits shown in FIG. 2 in some embodiments according to the invention.

### DETAILED DESCRIPTION OF EMBODIMENTS ACCORDING TO THE INVENTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive subject matter. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present inventive subject matter. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present inventive subject matter belongs. It will be further understood that terms used herein should be interpreted as having a meaning that is consistent with their meaning in the context of this specification and the relevant art and will not be interpreted in an idealized or overly formal sense unless expressly so defined herein. The term “plurality” is used herein to refer to two or more of the referenced item.

The following description of some embodiments of the inventive subject matter refers to “light-emitting devices,” which may include, but is not limited to, solid-state lighting devices, such as light emitting diode (LED) devices, As used herein, “LED” includes, but is not limited to, direct-emission devices that produce light when a voltage is applied across a PN junction thereof, as well as combinations of such direct-emission devices with luminescent materials, such as phosphors that emit visible-light radiation when excited by a source of radiation, such as a direct-emission device.

Embodiments of the present invention provide systems and methods for controlling solid state lighting devices and lighting apparatus incorporating such systems and/or methods. In some embodiments, the present invention can be utilized in connection with bypass circuits, using the current sensed in the LED string and the temperature associated therewith, as described in co-pending and commonly assigned U.S. patent application Ser. No. 12/566,195 entitled “Solid State Lighting Apparatus with Controllable Bypass Circuits and Methods of Operating Thereof” (Attorney Docket No. 5308-1128), co-pending and commonly assigned U.S. patent application Ser. No. 12/704,730 entitled “Solid State Lighting Apparatus with Compensation Bypass Circuits and Methods of Operation Thereof” (Attorney Docket No. 5308-11281P) and co-pending and commonly assigned U.S. patent application Ser. No. 12/566,142 entitled “Solid State Lighting Apparatus with Configurable Shunts” (Attorney Docket No. 5308-1091), the disclosures of which are incorporated herein by reference. Temperature compensation is described in co-pending and commonly assigned U.S. patent application Ser. No. 13/565,166, (P1513), entitled “Temperature Curve Compensation Offset” the disclosure of which is incorporated herein by reference.

LED segments described herein may be configured in a number of different ways and may have various compensation circuits associated therewith, as discussed, for example, in commonly assigned co-pending U.S. application Ser. No. 13/235,103 (Attorney Docket: 5308-1459) and U.S. application Ser. No. 13/235,127 (Attorney Docket 5308-1461), the disclosures of which is incorporated herein.

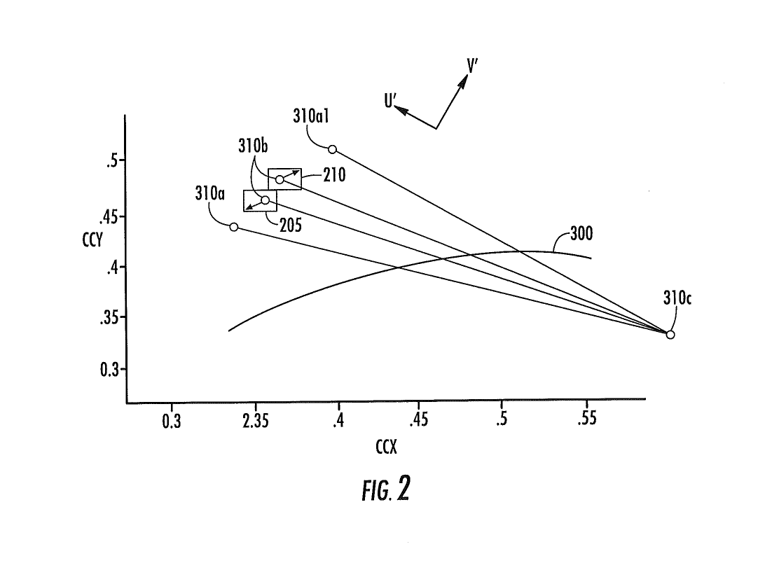

As appreciated by the present inventors, one of the reasons that a solid state lighting module may not generate light with a specified chromaticity value (such as a specified CCT value) is that the distribution of the light generated by some of the LEDs (such as the BSY LEDs) may be greater than expected, particularly in the v′ direction, as defined by the color space shown in FIG. 2. This can occur where, for example, a color distribution of the chromaticity of light emitted by an LED in a particular color bin is too wide or falls too near an edge of the bin. As further appreciated by the present inventors, if the LED modules fails to meet the specified chromaticity value, the module may need to be reworked to replace the out-of-spec LEDs, which may increase manufacturing costs. It will be understood that the term “specified chromaticity value” can be included on the packaging of the lighting apparatus or otherwise in conjunction with the advertising or marketing of the lighting apparatus, such as a particular CCT value (e.g. 2700K).

In some embodiments according to the invention, an LED string can include an additional bypass circuit that is configured to additionally adjust the chromaticity of light emitted by the string, in the v′ direction of the chromaticity coordinate space. In some embodiments according to the invention, the additional bypass circuit can be coupled in parallel with the additional LEDs that are situated in the CIE space higher or lower (in a v′ direction) than other LED(s) in the string.

The additional bypass circuits and associated LED(s) (in conjunction with an another bypass circuit coupled across other respective LEDs) can operate to provide an additional v′ lighting component that shifts the chromaticity of the combined light generated by the LED string in a selected direction in the u′-17′ space, that adjusts the light to again fall within an acceptable range of the specified chromaticity value. Accordingly, it will be understood that the additional v′ component may add to or subtract from the generated light in the v′ direction. Further, this “v′ tuning” can be carried out, for example, when the lighting apparatus is manufactured or otherwise before the lighting apparatus is installed.

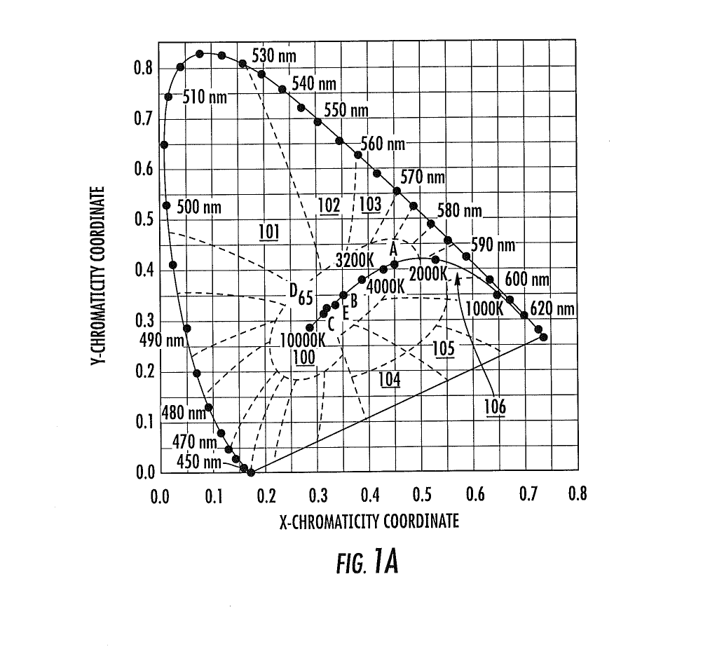

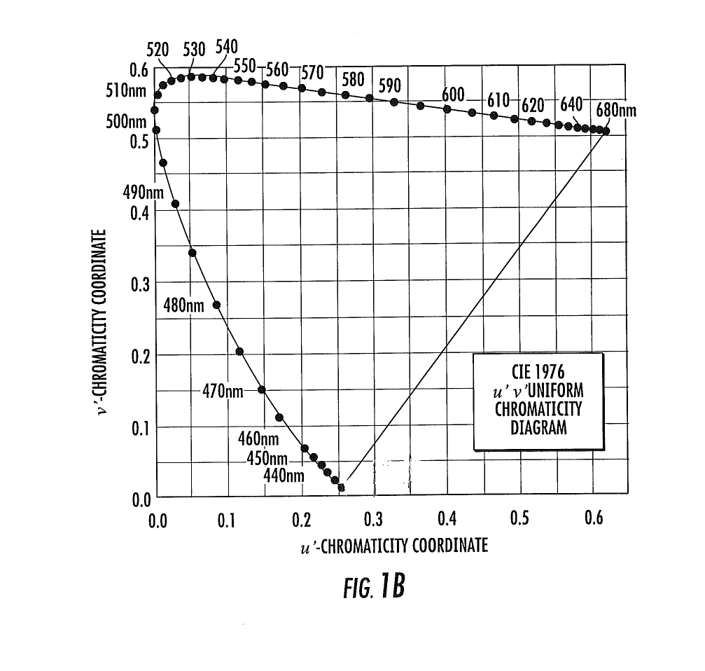

In some embodiments according to the invention, an additional LED component can be included (along with an associated bypass circuit) in a single string LED lighting apparatus to compensate for variation in the CCT of light otherwise generated by the lighting apparatus. Specifically, the compensation can be provided by the additional LED component/bypass circuit by shifting the CCT of the generated light in the v′ direction of the chromaticity space shown, for example, in FIG. 1. Accordingly, if during manufacturing it is determined that the CCT target for the lighting apparatus is not satisfied by standard modulation control signals provided to the LED string, an additional component can be provided in the v′ direction to shift the CCT value to within an acceptable range of the CCT target sought during manufacturing.

In still further embodiments according to the invention, multiple strings of LEDs can be used where, for example, at least two of the modulated LED segments are include in a string and at least one additional modulated LED segment is included in another string.

FIG. 2 is a schematic representation of an x-y chromaticity space diagram, annotated with offset u′ and v′ coordinate system axes, including a representation of the Planckian locus, in some embodiments according to the invention. According to FIG. 2, a single string LED lighting apparatus can include a red/orange (R/O) LED component 310c and blue-shifted-yellow (BSY) LED segment 310b which can nominally operate in conjunction with one another to provide a lighting product having a specified chromaticity value of, for example, 2700K. Assuming that the components included within the LED string are well within specification, the light generated by the LED string may be within an acceptable range of the specified chromaticity value. If, however, the BSY LEDs 310b, for example, are located near an outer boundary of specified distributions for those BSY LEDs 310b (205 and 210, respectively), the combined effect may generate light that varies unacceptably from the specified chromaticity value.

Accordingly, in some embodiments according to the invention, additional LEDs 310a1 and 310a2, may be included within the LED string along with associated bypass circuits in order to provide additional v′ components for the chromaticity of the light generated by the LED string. Accordingly, if it is determined that the chromaticity value of the light generated by the LED string should be adjusted (due to out-of-spec LEDs 310b, for example) the additional LED segment 310a1 or 310a2 may be provided with adjusted modulation signals to provide additional v′ components to shift the chromaticity value of the generated light in the appropriate direction to bring the emitted light back within an acceptable range of the specified chromaticity value.

Although the term “chromaticity” is used herein to generally described the color characteristics of LEDs, other terms may also be used to refer to well known aspects of color characterization, such as Correlated Color Temperature (CCT). It will be further understood that any characterization of the color of LEDs can be used in conjunction with embodiments of the present invention.

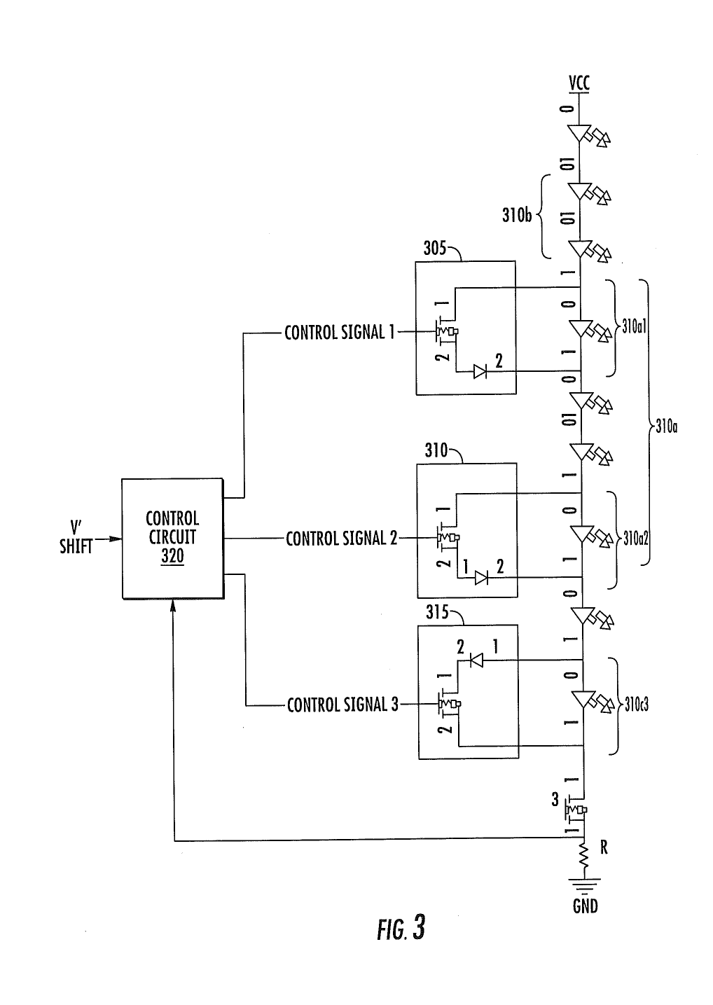

FIG. 3 is a schematic diagram illustrating a single string LED lighting apparatus including LED segments described above in reference to FIG. 2. In particular, a control circuit 320 provides modulation control signals 1-3 to the respective bypass circuits coupled across the associated LED segment 310a1 and 310a2 and 310c. If it were determined, during manufacturing for example, that the CCT value of the light generated by the single LED string was too high relative to the specified CCT value for the string, the control circuit 320 can be used to adjust the modulation control signal 1, for example, provided to the bypass circuit coupled across the additional LED segment 310a1 to provide an additional v′ component to the light generated by the single LED string in the positive v′ direction, thereby bringing the CCT value of the generated light within an acceptable range of the specified CCT value for the string.

If, however, it were determined during manufacturing that the CCT value of the light generated by the single LED string was too low relative to the acceptable distribution of the CCT target value, the control circuit 320 can adjust the modulation control signal 2, for example, provided to the bypass circuit 310 coupled across the additional LED segment 310a2 to provide an additional v′ component to the light generated by the single LED string in the negative v′ direction, thereby bringing the CCT value of the generated light within an acceptable range of the CCT target value.

It will be further understood that other adjustments can be made to the control signals described above to provide the same v′ shift to the light generated by the single string. For example, in some embodiments according to the invention, the positive v′ shift described above may also be provided by adjusting the modulation control signal 2 to the bypass circuit 310 while maintaining the modulation control signal 1 to the bypass circuit 305. Similarly, the negative v′ shift can be provided by adjusting the modulation control signal 1 to the bypass circuit 305 whereas the modulation control signal 2 to the bypass circuit 310 is maintained.

Still further, it will be understood that the control signals can take the form of pulse width modulation signals. In operation, the pulse width modulation signals are provided to the respective bypass circuits. When on, the pulse width modulation signals cause the current to bypass the corresponding LED segment. Increasing the “on” time of the pulse width modulation signal causes the bypass circuit to be enabled longer, which causes more current to bypass the LED segment, which generates less light. Accordingly, in some embodiments according to the invention, increasing the on time of the pulse width modulation signal to the bypass circuit 305 can cause the additional LED segment 310a1 to generate less light, which can provide a shift in the negative v′ direction.

It will also be understood that in a default configuration, the control circuit 320 can store nominal pulse width modulation signals to be provided to the corresponding bypass circuits. When, however, v′ shift is to be provided, the nominal pulse width modulation signals to the bypass circuits can be adjusted so that the corresponding LED segments generate more or less light to provide the determined v′ shift for the lighting apparatus.

In some embodiments according to the invention, the additional LEDs 310a1 can be positioned within the chromaticity space to have a ccx chromaticity value between about 0.55 and about 0.35, and a ccy chromaticity value greater than about 0.5. In some embodiments according to the invention, the additional LEDs 310a2 can be positioned within the chromaticity space to have a ccx chromaticity value greater than about 0.35 and a ccy chromaticity value less than about 0.44. In some embodiments according to the invention, the additional LEDs 310a1 can be configured to emit predominantly non-blue chromaticity light. In some embodiments according to the invention, the additional LEDs 310a1 can be configured to emit less than a saturated yellow chromaticity light.

It will be understood that although FIG. 3 illustrates a single string with a particular LED configuration, other configurations of LEDs arranged a single string can also be used. For example, in some embodiments of the invention, the LED segments can include more than one LED in series. In some embodiments according to the invention, the LED segments can include a parallel arrangement of LEDs, such as to LEDs in parallel in the segment. In still other embodiments according to the invention, a combination of additional LEDs in series as well as additional LEDs in parallel with one another in the segments can also be used. It will also be understood that term “single string” includes arrangements of LEDs where, for example, the current used for dimming the light emitted by the lighting apparatus is provided to the same input of all the LEDs arranged in the string. Other arrangements may also be used.

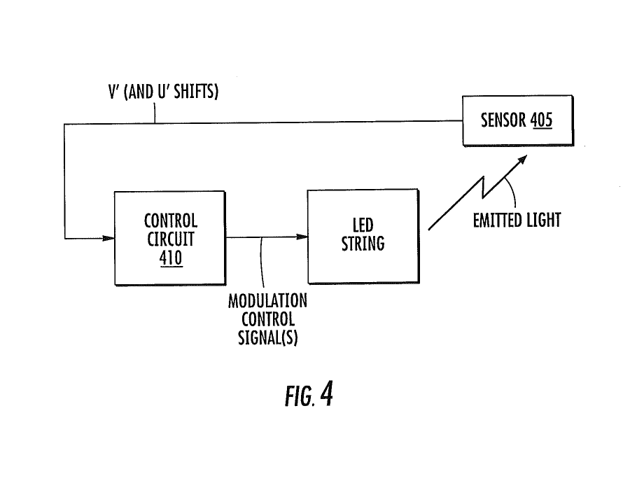

FIG. 4 is a block diagram illustrating a system for monitoring and determining a v′ shift for the single LED string in some embodiments according to the invention. According to FIG. 4, a sensor 405 may be utilized during the manufacturing process to measure the light generated by the LED string. The sensor 405 may determine the CCT value that characterizes the light generated by the LED string where a determination can be made if a v′ shift should be provided by the control circuit 410 in order to bring the emitted light back to within an acceptable range of the specified CCT value for the lighting apparatus. The sensor 405 can be any sensor that is configured to determine the color content of the light emitted by the LED string. For example, in some embodiments according to the invention, the sensor 405 comprises a colorimeter.

For example, in some embodiments according to the invention, the sensor 405 may be used to measure the emitted light, whereupon the control circuit 410 may determine the CCT value of the measured light and determine that the value is below the specified CCT value for the lighting apparatus in the v′ direction. In response, the control circuit 410 can adjust the pulse with modulation signals to shift the emitted light in the positive v′ direction to increase the CCT value to within an acceptable range of the CCT target value. The sensor 405 and control circuit 410 may iteratively measure and incrementally shift the emitted light to provide a series of positive adjustments to the v′ value until the CCT value is within an acceptable range of the CCT target value.

In contrast, if the control circuit 410 determines that the CCT value of the generated light exceeds the specified CCT value by more than an acceptable amount, the control circuit 410 may determine to provide a v′ shift in the negative direction by adjusting the pulse width modulation signal. The sensor 405 and control circuit 410 may iteratively measure and incrementally shift the emitted light to provide a series of negative adjustments to the v′ value until the CCT value is within an acceptable range of the specified CCT value.

Once the control circuit 410 determines the appropriate v′ shift for the single LED string, the control circuit 320 may store the value of the determined v′ shift so that it may be later utilized during operation of the single LED string in the field. For example, when the LED string is packaged into a lighting product and deployed by a customer, the control circuit 410 can operate the LED string with the stored v′ shift to ensure that the CCT value of the light generated by the LED string is in line with that specified.

It will also be understood that the LED string may be provided with different values for a v′ shift depending on the current provided through the string. For example, in some embodiments according to the invention, the LED string may be provided with a relatively high current to produce relatively high lumen output in conjunction with a first v′ shift value. In contrast, the same LED string may be provided with a lower current level to be used in conjunction with a second shift in the v′ direction based on the lower current value to approximate dimming. Accordingly, in operation the control circuit 320 can adjust the pulse width modulation signals with different v′ shifts as dimming changes so that when the single LED string is dimmed, the CCT value of the dimmed light remains substantially in conformance with the Plankian locus.

It will also be understood that in some embodiments according to the invention, the additional v′ component can be provided irrespective of dimming when, for example, during manufacturing, it is determined that (due to, for example, beyond specification variation in the distribution of the chromaticities of light emitted by the LEDs) the additional v′ component is provided to bring the light output back within specification regardless of dimming. Furthermore, an estimation of the change in the chromaticity of the emitted light over time can be used to provide the additional v′ component so that, over time, the additional v′ component can be incorporated into the control of the control signals for the additional bypass circuit so as to compensate for the chromaticity change due to time.

It will be understood that the control circuit 320 and the control circuit for 10 may be different control circuits or maybe different portions of the same control circuit. For example, in some embodiments according to the invention, the control circuit 410 can be a programmable logic controller that is associated with the system shown in FIG. 4, but is not included in the circuit shown in FIG. 3. In some embodiments according to the invention, the control circuit 410 can be a portion of the control circuit 320 which acts under the control of the system shown in FIG. 4 to modify the pulse width modulation control signals provided to the bypass circuits in order to provide the v′ tuning described herein. It will also be understood that the control circuit 410 shown in figure for an interface to the LED string using any appropriate technique, such as a direct connection, a wireless connection, an infrared connection, etc. In order to access the bypass circuits either directly or via the control circuit 320. Systems he used to measure and control color of light emitted by solid-state lighting is also discussed in, for example, commonly assigned U.S. Patent Publication No. 2009/0160363, the disclosure of which is incorporated herein by reference in its entirety.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In the drawings and specification, there have been disclosed typical preferred embodiments of the inventive subject matter and, although specific terms are employed, they are used in a generic and descriptive sense only and not for purposes of limitation, the scope of the inventive subject matter being set forth in the following claims.

What is claimed:

1. A method of adjusting a chromaticity of light emitted by a solid state lighting apparatus including a plurality of light-emitting devices (LEDs) coupled together in at least one string including a first modulated LED segment, a second modulated LED segment, and at least one additional modulated LED segment, the method comprising:
modulating the first modulated LED segment and/or the at least one additional modulated LED segment based on respective specified chromaticity values of the plurality of LEDs to provide the light substantially in conformance with a Planckian locus;
measuring the chromaticity of the light emitted by the at least one string to provide a measured chromaticity value; and
adjusting modulating the first modulated LED segment or the at least one additional modulated LED segment by a shift value based on a difference between the measured chromaticity value and a specified chromaticity value to provide an additional v′ shift in light toward the Planckian locus.

2. The method of claim 1 wherein modulating comprises applying respective pulse width modulation signals to respective bypass circuits to conduct respective currents around the first modulated LED segment and/or the at least one additional modulated LED segment to emit a first chromaticity light and an additional chromaticity light, respectively.

3. The method of claim 2 wherein adjusting modulating comprises changing at least one of the respective pulse width modulation signals to the respective bypass circuits by the shift value to shift the light in a v′ direction toward the specified chromaticity value.

4. The method of claim 3 further comprising:
storing the shift value for use during operation of the lighting apparatus after installation.

5. The method of claim 3 wherein the shift value increases an on time of the respective pulse width modulation signal if a specified chromaticity value of the light emitted by the apparatus is less than the measured chromaticity of the light.

6. The method of claim 5 wherein the specified chromaticity value of the light emitted by the apparatus is less than the measured chromaticity value in the v′ direction of a u′-v′ chromaticity coordinate space.

7. The method of claim 5 wherein the shift value decreases an on time of the respective pulse width modulation signal if the specified chromaticity value of the light emitted by the apparatus is greater than the measured chromaticity value in the v′ direction of a u′-v′ chromaticity coordinate space.

8. The method of claim 1 wherein the first modulated LED segment includes BSY LEDs and the at least one additional modulated LED segment includes BSY-Y LEDs.

9. The method of claim 1 wherein the at least one additional modulated LED segment includes LEDs that are configured to emit additional chromaticity light comprising a ccy coordinate value greater than about 0.5 in an x-y chromaticity space.

10. The method of claim 1 wherein the at least one additional modulated LED segment includes LEDs that are configured to emit additional chromaticity light comprising a ccx coordinate value between about 0.55 and about 0.35 in an x-y chromaticity space.

11. The method of claim 1 wherein the at least one additional modulated LED segment includes LEDs that are configured to emit additional chromaticity light comprising a predominant non-blue chromaticity.

12. The method of claim 1 wherein the at least one additional modulated LED segment includes LEDs are configured to emit additional chromaticity light comprising less than a saturated yellow chromaticity.

13. The method of claim 1 further comprising:
iteratively repeating the measuring the chromaticity of the light and then the adjusting modulating until the measured chromaticity value resulting from the shift value is within range of a specified chromaticity value of the light emitted by the apparatus.

14. The method of claim 13 wherein the range comprises a predetermined number of MacAdam ellipsis.

15. The method of claim 13 further comprising:
reducing a string current to the at least one string to dim an intensity of the light emitted by the apparatus to a specified CCT value to provide a dimmed light;
iteratively repeating measuring the chromaticity of the dimmed light and then the adjusting modulating until the measured chromaticity value resulting from the shift value is within range of a specified chromaticity value of the dimmed light emitted by the apparatus.

16. A system to adjust a chromaticity of light emitted by a solid state lighting apparatus including a plurality of light-emitting devices (LEDs) coupled together in a at least one string including a first modulated LED segment, a second modulated LED segment, and at least one additional modulated LED segment, the system comprising:
a colorimeter configured to measure the chromaticity of the light emitted by the apparatus to provide a measured chromaticity value;
a control circuit coupled to the colorimeter to receive the measured chromaticity value and configured to couple to the solid state lighting apparatus, wherein the control circuit is configured to modulate the first modulated LED segment and/or the at least one additional modulated LED segment based on respective specified chromaticity values of the plurality of LEDs to provide the light substantially in conformance with a Planckian locus;
wherein the control circuit is configured to adjust modulation of the first modulated LED segment or the at least one additional modulated LED segment by a shift value based on a difference between the measured chromaticity value and a specified chromaticity value to provide an additional v′ shift in light toward the Planckian locus.

17. The system of claim 16 wherein the control circuit is configured to modulate by applying respective pulse width modulation signals to respective bypass circuits to conduct respective currents around the first modulated LED segment and/or the at least one additional modulated LED segment to emit a first chromaticity light and an additional chromaticity light, respectively.

18. The system of claim 17 wherein the control circuit is configured to adjust modulating by changing at least one of the respective pulse width modulation signals to the respective bypass circuits by the shift value to shift the light in av' direction toward the specified chromaticity value.

19. The system of claim 18 wherein the control circuit is configured to store the shift value for use during operation of the lighting apparatus after installation.

20. The system of claim 18 wherein the shift value increases an on time of the respective pulse width modulation signal if a specified chromaticity value of the light emitted by the apparatus is less than the measured chromaticity value.

21. The system of claim 16 wherein the control circuit is configured to iteratively repeat measuring the chromaticity of the light and then adjust modulating until the measured chromaticity value resulting from the shift value is within range of a specified chromaticity value of the light emitted by the apparatus.

22. The system of claim 21 wherein the range comprises a predetermined number of MacAdam ellipsis.

23. The system of claim 21 wherein the control circuit is configured to reduce a string current to the at least one string to dim an intensity of the light emitted by the apparatus to a specified CCT value to provide a dimmed light and is configured to iteratively repeat measuring the chromaticity of the dimmed light and then adjust modulating until the measured chromaticity value resulting from the shift value is within range of a specified chromaticity value of the dimmed light emitted by the apparatus.

24. A method of operating a lighting apparatus including a single string of a plurality of light-emitting devices (LEDs) comprising at least one first LED configured to emit first chromaticity light, at least one second LED configured to emit second chromaticity light, and at least one additional LED configured to emit additional chromaticity light, the method comprising:
measuring a CCT value for light emitted by the single string; and
adjusting current through the at least one additional LED using pulse width modulation responsive to determining that the CCT value for the light emitted by the single string is outside a predetermined specified CCT value in a v′ direction of a chromaticity coordinate space.

25. A method of adjusting a chromaticity of light emitted by a solid state lighting apparatus including a plurality of light-emitting devices (LEDs) including a first modulated LED segment in a string, a second modulated LED segment in the string, and at least one additional modulated LED segment, the method comprising:
modulating the first modulated LED segment and/or the at least one additional modulated LED segment based on respective specified chromaticity values of the plurality of LEDs to provide the light substantially in conformance with a Planckian locus;
measuring the chromaticity of the light emitted by the apparatus to provide a measured chromaticity value; and
adjusting modulating the first modulated LED segment or the at least one additional modulated LED segment by a shift value based on a difference between the measured chromaticity value and a specified chromaticity value to provide an additional v′ shift in light toward the Planckian locus.

26. The method of claim 25 wherein modulating comprises modulating in response to an input to change the chromaticity value of light emitted by the string.

27. The method of claim 25 wherein the shift value is determined before installation of the apparatus.
